(19) United States
(12) Patent Application Publication
(10) Pub. No.: US 2015/0116612 A1
(43) Pub. Date: Apr. 30, 2015

(54) DISPLAY DEVICE AND METHOD FOR DRIVING THE SAME

(71) Applicant: SAMSUNG DISPLAY CO., LTD., YONGIN-CITY (KR)

(72) Inventors: JIN OH SONG, Seoul (KR); Kang-Min Kim, Hwaseong-Si (KR); Il-Joo Kim, Hwaseong-Si (KR); Yoon Kyung Park, Seoul (KR); Hyung Woo Yim, Goyang-Si (KR); Chun Ki Choi, Yongin-Si (KR)

(73) Assignee: SAMSUNG DISPLAY CO., LTD., YONGIN-CITY (KR)

(21) Appl. No.: 14/258,955

(22) Filed: Apr. 22, 2014

(30) Foreign Application Priority Data
Oct. 25, 2013 (KR) 10-2013-0128084

(51) Int. Cl. G02F 1/133; G02B 27/22

(52) U.S. Cl. CPC G02F 1/13306; G02B 27/2214
USPC 349/15; 349/37

(57) ABSTRACT

A display device and a driving method thereof is provided. The display device includes a display panel displaying an image and a liquid crystal lens panel including a liquid crystal lens. The liquid crystal lens panel includes a first electrode layer, and a second electrode layer. The first electrode layer includes a plurality of electrodes. A common voltage is applied to the second electrode layer. First and second voltages are applied to first and second electrodes, respectively. The first and second electrodes are in a first zone and a second zone, respectively and are adjacent to a boundary between the first zone and a second zone.

### CROSS-REFERENCE TO RELATED PATENT APPLICATION

This application claims priority under 35 U.S.C. §119 to Korean Patent Application No. 10-2013-0128084 filed on Oct. 25, 2013 in the Korean Intellectual Property Office, the disclosure of which is incorporated by reference herein in its entirety.

### TECHNICAL FIELD

The present invention relates to a display device, and more particularly to a display device and a method for driving the display device.

### DISCUSSION OF THE RELATED ART

A method for displaying a three-dimensional (3D) image may use a binocular disparity. The binocular disparity may use a display device that sends distinct image to a view's left and right eyes. The distinct images may feature a common image observed from different angles. Thus, since the images viewed at different angles are input to both eyes of an observer, the observer may feel a 3D effect.

Methods for inputting the images to both eyes of the observer include a method of using a barrier, a method of using a lenticular lens (e.g., a cylindrical lens), or the like.

In the method using the barrier, a slit is formed in the barrier and thus the image from the display device is divided into a left eye image and a right eye image through the slit to be input to the left eye and the right eye of the observer, respectively.

The 3D image display device using the lens displays the left eye image and the right eye image, respectively, and divides the image from 3D image display device into the left eye image and the right eye image by changing a light path using the lens.

Since an image display device that is capable of displaying both of 2D and 3D modes is in the limelight, a switchable lens that enables switching between the 2D and 3D modes has been developed.

### SUMMARY

According to an exemplary embodiment of the present invention, a display device is provided. The display device includes a display panel, a liquid crystal lens panel. The display panel is configured to display an image. The liquid crystal lens panel includes a liquid crystal lens and includes a first substrate, a second substrate, a liquid crystal layer, a first electrode layer, and a second electrode layer. The second substrate faces the first substrate. The liquid crystal layer is positioned between the first substrate and the second substrate. The first electrode layer is formed on the first substrate. The first electrode layer includes a plurality of electrodes formed on one or more layer. The second electrode layer is formed on the second substrate and a common voltage is applied to the second electrode layer. A first voltage is applied to a first electrode that is included in a first zone in the liquid crystal lens, the first electrode is adjacent to a boundary between the first zone and a second zone in the liquid crystal lens. A second voltage is applied to a second electrode that is included in the second zone, the second electrode is adjacent to the boundary between the first zone and the second zone. The first voltage and the second voltage have opposite polarities to each other with respect to the common voltage and at least one of the first voltage and the second voltage is overdriven or underdriven.

The first voltage having a smaller absolute voltage than the second voltage may be overdriven.

The second voltage having a larger absolute voltage than the first voltage may be underdriven.

The display device may further include a driver and a controller. The driver may be configured to supply the first voltage and the second voltage to the liquid crystal lens panel. The controller may be configured to control the driver based on at least one lookup table.

The display device may further include a memory configured to store the at least one lookup table.

The overdriving of the first voltage may be performed based on a lookup table.

The underdriving of the second voltage may be performed based on a lookup table.

The first electrode may be an electrode to which a smallest absolute voltage is applied among electrodes in the first zone, and the second electrode may be an electrode to which a largest absolute voltage is applied among electrodes in the second zone.

A difference between the first voltage and the common voltage may be larger than zero, and a difference between the second voltage and the common voltage may be larger than zero.

According to an exemplary embodiment of the present invention, a driving method of a display device is provided. The method includes receiving a mode signal by a controller of a liquid crystal lens panel and operating the liquid crystal lens panel in a 3D mode when the mode signal is a signal representing the 3D mode. The operating of the liquid crystal lens includes applying a first voltage to a first electrode that is included in a first zone of a liquid crystal lens in the liquid crystal lens panel, applying a second voltage to a second electrode that is included in the second zone, and performing at least one of operations between overdriving and underdriving on the first voltage or the second voltage. The first electrode and the second electrode are adjacent to a boundary between the first zone and a second zone of the liquid crystal lens. The first voltage and the second voltage have opposite polarities to each other with respect to the common voltage.

Voltages applied to electrodes in each of the first zone and the second zone may vary stepwise and differences of the voltages from the common voltage may gradually decrease toward the center of the liquid crystal lens from the outer side.

The underdriving may be performed by charge sharing. The charge sharing may include short-circuiting the first electrode and the second electrode during a predetermined time.

The liquid crystal lens panel may operate in a 2D mode or a 3D mode, and the liquid crystal lens may operate as a Fresnel zone plate when the liquid crystal lens operates in the 3D mode.

According to an exemplary embodiment of the present invention, a display device is provided. The display device includes a display panel and a liquid crystal lens panel. The display panel is configured to display an image. The liquid crystal lens panel includes a liquid crystal lens and includes a first electrode layer and a second electrode layer. The first electrode layer has a first zone and a second zone. Each of the first zone and the second zone includes a plurality of electrodes. The first and second zones are adjacent to each other. A common voltage is applied to the second electrode layer. A first voltage is applied to a first electrode that is included in the first zone and the first electrode is adjacent to a boundary between the first zone and the second zone. A second voltage is applied to a second electrode that is included in the second zone and the second electrode is adjacent to the boundary between the first zone and the second zone. The first voltage and the second voltage have opposite polarities to each other with respect to the common voltage. An absolute voltage of the first voltage is smaller than an absolute voltage of the second voltage. The first voltage is overdriven and the second voltage is underdriven.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIGS. 1 and 2 are diagrams illustrating a structure of a display device forming a 2D image and a 3D image, according to an exemplary embodiment of the present invention;

FIG. 3 is a cross-sectional view of a liquid crystal lens panel of the display device, according to an exemplary embodiment of the present invention;

FIG. 4 is a graph illustrating a phase delay change according to a position of a phase modulation type Fresnel zone plate;

FIG. 5 is a cross-sectional view illustrating a part of a liquid crystal lens in the liquid crystal lens panel of the display device according to an exemplary embodiment of the present invention;

FIG. 6 is a diagram illustrating a phase delay formed as a result of a position at the liquid crystal lens of FIG. 5, according to an exemplary embodiment of the present invention;

FIG. 7 is a diagram illustrating an example of a voltage applied to the liquid crystal lens panel in the display device, according to an exemplary embodiment of the present invention;

FIG. 8 is a diagram illustrating an example of a capacitance generated in two electrodes adjacent to a zone boundary when the voltages illustrated in FIG. 7 are applied to the liquid crystal lens panel;

FIG. 9 is a diagram illustrating a simulation result of coupling generated between electrodes adjacent to a zone boundary;

FIGS. 10 and 11 are diagrams illustrating voltage waveforms applied to the electrodes adjacent to a zone boundary, according to an exemplary embodiment of the present invention;

FIG. 12 is a diagram illustrating a waveform of a response voltage when electrodes adjacent to a zone boundary are driven by voltage waveforms, according to exemplary embodiments of the present invention;

FIG. 13 is a diagram illustrating a simulation result of coupling generated between electrodes adjacent to a zone boundary depending on driving voltage according to an exemplary embodiment of the present invention; and

FIG. 14 is a block diagram illustrating a configuration of the liquid crystal lens panel in the display device, according to an exemplary embodiment of the present invention.

FIG. 15 is a flow chart illustrating a method of driving a display device according to an exemplary embodiment of the present invention.

### DETAILED DESCRIPTION OF THE EMBODIMENTS

The present invention will be described more fully hereinafter with reference to the accompanying drawings, in which exemplary embodiments of the invention are shown. However, the present invention may be embodied in various forms without departing from the spirit or scope of the present invention.

In the drawings, the thickness of layers, films, panels, regions, etc., may be exaggerated for clarity. Like reference numerals may refer like elements throughout the specification and drawings.

Hereinafter, a display device according to an exemplary embodiment of the present invention will be described in detail with reference to the accompanying drawings.

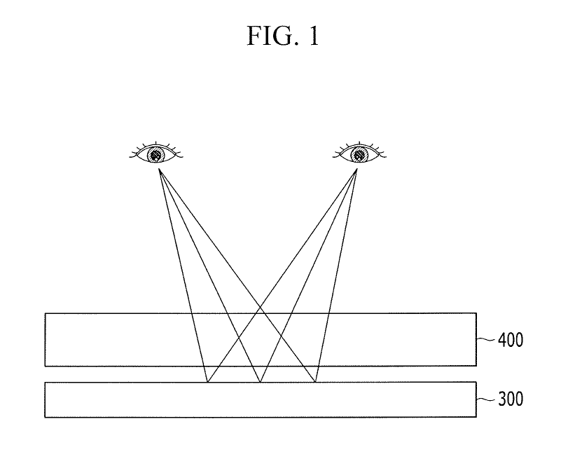

FIGS. 1 and 2 are diagrams illustrating a structure of a display device for displaying a 2D image and a 3D image according to an exemplary embodiment of the present invention.

A display device includes a display panel 300 displaying an image, and a liquid crystal lens panel 400 positioned at front of a surface (screen) on which the image of the display panel 300 is displayed. The display panel 300 and the liquid crystal lens panel 400 may operate in either a 2D mode or a 3D mode.

The display panel 300 may include various flat panel displays such as a liquid crystal display, an organic light emitting diode display, a plasma display device, an electrophoretic display, or the like. The display panel 300 includes a plurality of pixels which may be arranged in a matrix form. In the 2D mode, the display panel 300 may display one 2D image in the 2D mode. In the 3D mode, the display panel 300 may alternately display images corresponding to various viewing fields (e.g., a right-eye image and a left-eye image) by a spatial or temporal division method. For example, the display panel 300 may alternately display the right-eye image and the left-eye image for each pixel array in the 3D mode.

In the 2D mode, the liquid crystal lens panel 400 transmits the image displayed on the display panel 300. In the 3D mode, the liquid crystal lens panel 400 separates the viewing fields of the image of the display panel 300. For example, the liquid crystal lens panel 400 operating in the 3D mode focuses a multi-view point image, which includes the left-eye image and the right-eye image displayed on the display panel 300, on a corresponding viewing field for each view point image by using diffraction and refraction of light.

FIG. 1 illustrates a case where the display panel 300 and the liquid crystal lens panel 400 operate in the 2D mode. As illustrated in FIG. 1, the same image reaches the left eye and the right eye. Thus, the 2D image is recognized. FIG. 2 illustrates a case where the display panel 300 and the liquid crystal lens panel 400 operate in the 3D mode. As illustrated in FIG. 2, the liquid crystal lens panel 400 divides the image of the display panel 300 into distinct viewing fields (e.g., the left eye and the right eye) and refracts the divided image. Thus, the 3D image is recognized.

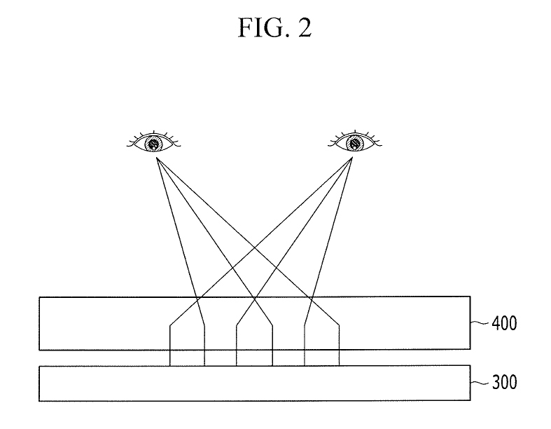

FIG. 3 is a cross-sectional view of a liquid crystal lens panel of the display device according to an exemplary embodiment of the present invention.

Referring to FIG. 3, the liquid crystal lens panel 400 includes a first substrate 110 and a second substrate 210. The first substrate 110 and the second substrate 210 may be made of an insulating material such as glass and plastic and the first and second substrates may face each other. A liquid crystal layer 3 is interposed between the two substrates 110 and 210. Polarizers (not illustrated) may be provided on outer surfaces of the first substrate and the second substrate 110 and 210.

A first electrode layer 190 and an alignment layer 11 may be sequentially formed on the first substrate 110 and may be interposed between the first substrate 110 and the liquid crystal layer 3. A second electrode layer 290 and an alignment layer 21 may be sequentially formed on the second substrate 210 and may be interposed between the second substrate 210 and the liquid crystal layer 3.

The first electrode layer 190 and the second electrode layer 290 may include a plurality of electrodes and may be made of a transparent conductive material such as Indium tin oxide (ITO) or Indium zinc oxide (IZO). The first electrode layer 190 and the second electrode layer 290 generate an electric field in the liquid crystal layer 3 using an applied voltage and control alignment of liquid crystal molecules of the liquid crystal layer 3.

The alignment layers 11 and 21 determine initial alignment of the liquid crystal molecules of the liquid crystal layer 3 and predetermine alignment directions of the liquid crystal molecules to be rapidly aligned according to the electric field generated in the liquid crystal layer 3.

The liquid crystal layer 3 may be aligned in various modes such as a horizontal alignment mode, a vertical alignment mode, a twisted nematic (TN) mode, or the like.

The liquid crystal lens panel 400 operates in either the 2D mode or the 3D mode according to the voltage applied to the first electrode layer 190 and the second electrode layer 290. For example, when the voltage is not applied to the first electrode layer 190 nor the second electrode layer 290, the liquid crystal lens panel 400 operates in the 2D mode. When the voltage is applied to the first electrode layer 190 and the second electrode layer 290, the liquid crystal lens panel 400 may operate in the 3D mode. To this end, the initial alignment directions of the liquid crystal molecules 31 and transmissive axis directions of the polarizers may be properly controlled.

Hereinafter, the liquid crystal lens panel 400 operating in the 3D mode will be described.

The liquid crystal lens panel 400 operating in the 3D mode includes a plurality of liquid crystal lenses. The plurality of liquid crystal lenses may be repetitively arranged at a predetermined period in one direction of the liquid crystal lens panel 400. A position of the liquid crystal lens in the liquid crystal lens panel 400 may be fixed, or may be changed with time.

One liquid crystal lens may be implemented by a Fresnel zone plate. The Fresnel zone plate serves as a lens by using diffraction of light through a plurality of concentric circles. The plurality of concentric circles may be radically arranged like a Fresnel zone and distances among the concentric circles may be narrowed toward an outer side from the center.

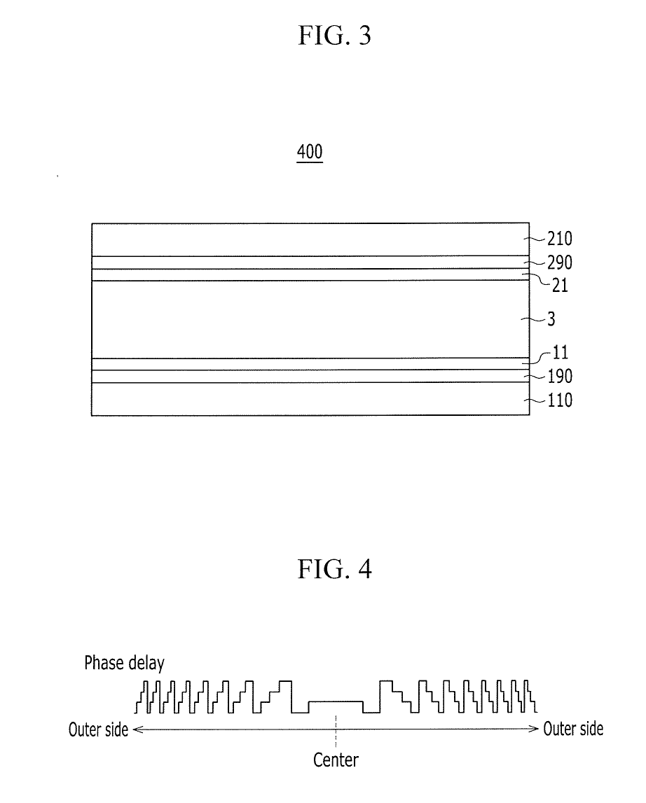

FIG. 4 is a graph illustrating a phase delay change according to a position of a phase modulation type Fresnel zone plate. Here, each zone of the Fresnel zone plate becomes a region to which a repeated waveform belongs.

Referring to FIG. 4, a phase delay in each zone is changed step-by-step. In the zone at the center, the phase delay is changed in two steps, and in the zones except for the center, the phase delays are changed in four steps. However, in the present inventive concept, the number of steps in which the phase delay is changed in each zone is not limited thereto.

As illustrated in FIG. 4, the Fresnel zone plate in which the phase delay is changed step-by-step in each zone is called a “multi-level phase modulation zone plate”. The liquid crystal lens panel may refract light to be collected at a focus position through refraction, and destructive interference, and constructive interference of light passing through each zone. As such, a phase delay distribution is formed according to the Fresnel zone plate for each liquid crystal lens of the liquid crystal lens panel to generate a lens effect.

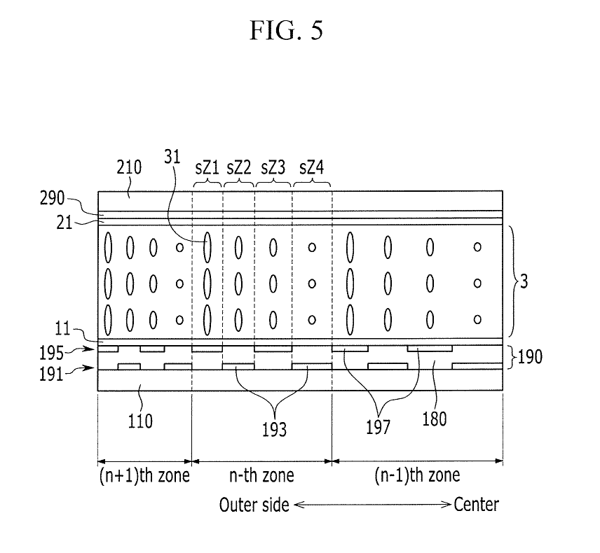

FIG. 5 is a cross-sectional view illustrating a part of a liquid crystal lens in the liquid crystal lens panel of the display device according to an exemplary embodiment of the present invention. The same constituent elements as the exemplary embodiment of FIG. 3 may designate the same reference numerals, and thus, the duplicated description is omitted.

Referring to FIG. 5, the liquid crystal lens panel includes a first substrate 110 and a second substrate 210 facing each other. A liquid crystal layer 3 is interposed between the two substrates 110 and 210. A first electrode layer 190 and an alignment layer 11 may be sequentially formed on the first substrate 110 and may be interposed between the first substrate 110 and the liquid crystal layer 3. A second electrode layer 290 and an alignment layer 21 may be sequentially formed on the second substrate 210 and may be interposed between the second substrate 210 and the liquid crystal layer 3.

The first electrode layer 190 includes a plurality of electrodes. The plurality of electrodes may be formed on one or more layers having an insulating layer between the layers. For example, the first electrode layer 190 may include a first electrode array 191, a second electrode array 195, and an insulating layer 180. The first electrode array 191 may include a plurality of first electrodes 193 and the second electrode array 195 may include a plurality of second electrodes 197. The insulating layer 180 may be formed on the first electrode array 191 and the second electrode array 195 may be formed on the insulating layer 180.

The first electrode 193 and the second electrode 197 may be alternately positioned in a horizontal direction, and might not overlap each other. In FIG. 5, edges of the first electrode 193 and the second electrode 197 which are adjacent to each other do not overlap each other, but a part of the edges may slightly overlap each other.

A horizontal width of each of the first electrode 193 and the second electrode 197, a distance between the first electrodes 193, and a distance between the second electrodes 197 are gradually decreased toward the outer side from the center of the liquid crystal lens, and gradually decreased toward the outer side from the center in each zone. Two of the first electrode 193 and two of the second electrode 197 are positioned in each zone of the liquid crystal lens, such as an n−1-th zone, an n-th zone, and an n+1-th zone. In each zone, a region where each of the electrodes 193 and 197 is positioned forms one sub-zone sZ1, sZ2, sZ3, or sZ4. Referring to FIG. 5, for example, in the n-th zone, the sub-zones from the outer side to the center are represented as sZ1, sZ2, sZ3, and sZ4 in sequence. In FIG. 5, each zone includes four sub-zones sZ1, sZ2, sZ3, and sZ4, but the number of sub-zones included in each zone is not limited thereto. Unlike those illustrated in FIG. 5, the horizontal width of each of the first electrode 193 and the second electrode 197 included in a zone may be uniform, and the number of electrodes 193 and 197 included in each zone may decrease toward the outer side.

The insulating layer 180 may be made of an inorganic insulator, an organic insulator, or the like, and is electrically insulated between the first electrode array 191 and the second electrode array 195.

The second electrode layer 290 is formed on the entire surface of the second substrate 210 and receives a predetermined voltage such as a common voltage Vcom. The second electrode layer 290 may be made of a transparent conductive material such as ITO or IZO.

The alignment layers 11 and 21 may be rubbed in a longitudinal direction (e.g., a direction vertical to a surface of the drawing) which is vertical to a lateral direction of the first electrode 193 and the second electrode 197 or in a direction having a predetermined angle to the longitudinal direction. The rubbing directions of the alignment layer 11 and the alignment layer 21 may be opposite to each other.

The liquid crystal molecules 31 of the liquid crystal layer 3 may be initially aligned in a direction which is horizontal to the surfaces of the substrates 110 and 210, but the alignment mode of the liquid crystal layer 3 is not limited thereto. For example, the liquid crystal molecules 31 of the liquid crystal layer 3 may be initially aligned in a direction which is substantially vertical to the surfaces of the substrates 110 and 210.

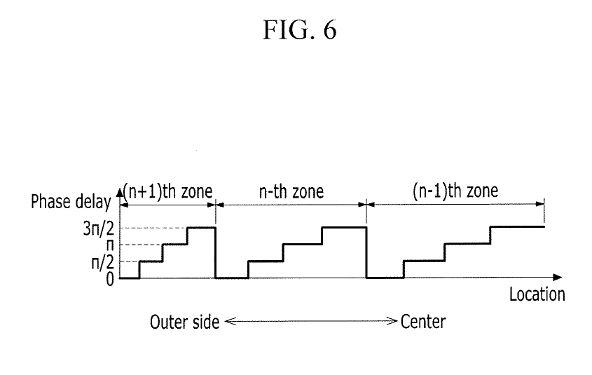

FIG. 6 is a diagram illustrating a phase delay formed according to a position at the liquid crystal lens of FIG. 5 according to an exemplary embodiment of the present invention. The liquid crystal lens panel is implemented by a phase modulation Fresnel zone plate for each liquid crystal lens.

Referring to FIG. 6, each phase delay of the (n−1)-th zone, the n-th zone, and the (n+1)-th zone of the liquid crystal lens is changed in four steps. Accordingly, the liquid crystal lens panel forms a phase delay distribution according to the Fresnel zone plate to generate a lens effect.

In each of the plurality of zones, the phase delay is increased step-by-step from the outer side to the center. The same sub-zone in each zone may cause the same phase delay. A slope of the phase delay at the zone boundary may be substantially vertical.

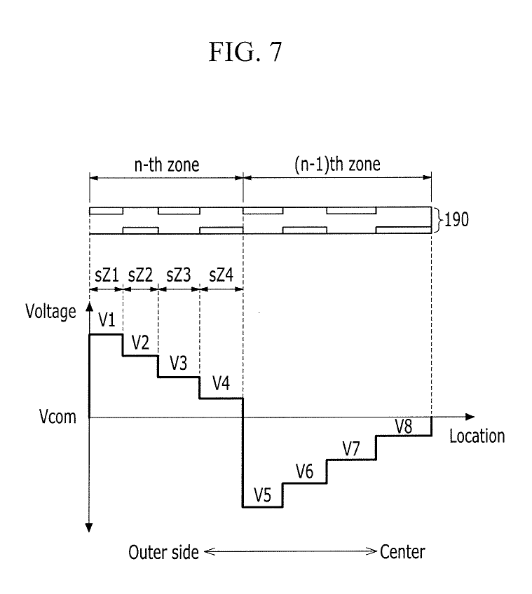

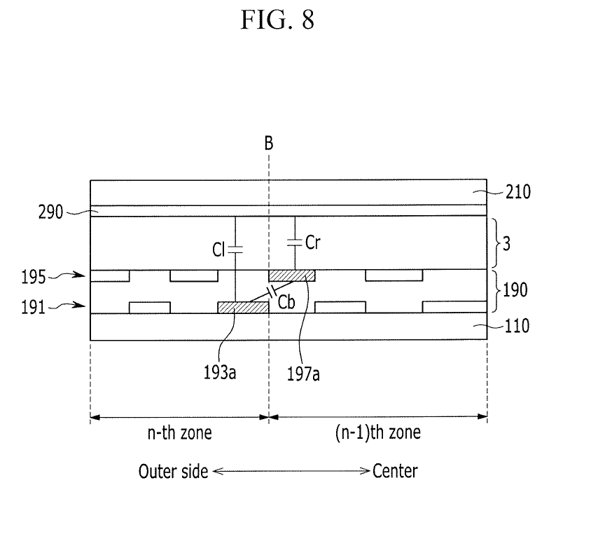

FIG. 7 is a diagram illustrating an example of a voltage applied to the liquid crystal lens panel in the display device according to an exemplary embodiment of the present invention, and FIG. 8 is a diagram illustrating an example of a capacitance generated in two electrodes adjacent to a zone boundary when the voltages illustrated in FIG. 7 are applied to the liquid crystal lens panel. The same constituent elements as the exemplary embodiment of FIG. 5 may designate the same reference numerals, and thus, the duplicated description is omitted.

Referring to FIG. 7, the common voltage Vcom is applied to the second electrode layer 290 of the liquid crystal lens panel. In the liquid crystal lens panel, a voltage higher than the common voltage Vcom (e.g., a voltage having a positive (+) polarity relative to the common voltage Vcom) is applied to the first electrode layer 190 of the n-th zone of the liquid crystal lens, and a voltage lower than the common voltage Vcom (e.g., a voltage having a negative (−) polarity relative to the common voltage Vcom) is applied to the first electrode layer 190 of the (n−1)-th zone of the liquid crystal lens. The polarity of the voltages relative to the common voltage Vcom applied to the first electrode layer 190 may be inverted for each zone, and this inversion is called a “space inversion”. Hereinafter, the polarity of the voltages relative to the common voltage Vcom is referred as “the polarity of the voltages”. Accordingly, directions of electric fields generated in adjacent zones are opposite to each other. Further, the polarity of the voltage applied to each electrode of the first electrode layer 190 may be inverted every time (e.g., a frame), and this inversion is called a “time inversion”.

The electrode of the first electrode layer 190 of each zone receives a stepped voltage in which a voltage difference with the common voltage Vcom is gradually decreased from the outer side to the center. The same voltage may be applied to electrode corresponding to the same sub-zone for each zone and thus, the same phase delay is generated at the same sub-zone for each zone. Hereinafter, voltages applied to sub-zones sZ1, sZ2, sZ3, and sZ4 of the n-th zone and sub-zones sZ1, sZ2, sZ3, and sZ4 of the (n−1)-th zone from the outer side to the center are referred to as V1, . . . , V8 in sequence.

When the polarity of the voltage in the n-th zone is positive (+) and the polarity of the voltage of the (n−1)-th zone is negative (−), the voltages V1 to V8 may satisfy the following Equation (1).

{P(V1−Vcom)=P(V5−Vcom)}>{P(V2−Vcom)=P(V6−Vcom)}>{P(V3−Vcom)=P(V7−Vcom)}>{P(V4−Vcom)=P(V8−Vcom)} (1)

Here, P(V) represents a phase delay of light having a predetermined single wavelength and being vertically incident to the liquid crystal layer 3 when rearrangement of upper liquid crystal directors of electrodes having a voltage difference V from the common electrode occurs. The rearrangement of upper liquid crystal directors of the electrodes occurs due to the voltage difference V between the electrodes and the common electrode.

A difference between either the voltage V4 or the voltage V8 and the common voltage Vcom is called an offset voltage a (e.g., a=V4−Vcom or Vcom−V8). The voltages V4 and V8 are applied voltages to the electrodes at the closest positions to the center in each of the n-th zone and the (n−1) zone. In FIG. 7, the offset voltage a may be controlled, and may vary according to a position of the zone even in one liquid crystal lens.

Referring to FIGS. 7 and 8, a difference (e.g., dV=V4−V5) between the voltages V4 and V5 applied to the two electrodes 193a and 197b adjacent to the zone boundary may be set by a difference (e.g., dVmax=V1−V4) between the voltage V1 which is applied to the electrode at the outmost position from the center in the n-th zone and the voltage V4 which is applied to the electrode at the closest position to the center in the n-th zone and the offset voltage a. In addition, the difference (e.g., dV=V4−V5) between the voltages V4 and V5 may be set by a difference (e.g., dVmax=V8−V5) between the voltage V8 which is applied to the electrode at the closest position to the center in the (n−1)-th zone and the voltage V5 which is applied to the electrode at the outmost position from the center in the (n−1)-th zone and the offset voltage a. The voltage difference dV may vary according to a position of a zone within one liquid crystal lens.

Since the electrodes of the first electrode layer 190 of each zone receive the stepped voltages in which the differences from the common voltage Vcom gradually decrease toward the center from the outer side, the difference dV between the voltages V4 and V5 is much larger than the difference between the voltages applied to the two adjacent electrodes in each zone. Thus, coupling generated between the two electrodes 193a and 197a adjacent to the zone boundary is much larger than coupling generated between two different electrodes in the zone.

Referring to FIG. 8, in the two electrodes 193a and 197a adjacent to the zone boundary, a capacitance Cl between the first electrode 193a and the second electrode layer 290, a capacitance Cr between the second electrode 197a and the second electrode layer 290, and a capacitance Cb between the first electrode 193a and the second electrode 197a may be considered. When the voltage difference dV between the two electrodes 193a and 197a is large, a coupling effect during polarity inversion of voltages applied to the two electrodes 193a and 197a is increased. Hereinafter, a voltage applied to an electrode is referred to as an “input voltage” and a voltage generated at the electrode when such input voltage is applied to the electrode is referred to a “response voltage”. For example, a response voltage of an electrode (e.g., the first electrode 193a) applying an input voltage (e.g., V4) having a relatively small absolute value might not be immediately inverted to the opposite polarity and may be delayed. For example, the delay during the polarity inversion at an electrode (e.g., the first electrode 193a) applying an input voltage (e.g., V4) having a relatively small absolute value may be longer than delays occurring in other electrodes in the zone. Hereinafter, an input voltage having a relatively small absolute value is referred to as “low input voltage” and an input voltage having a relatively large absolute value is referred to as “high input voltage”.

When a response voltage of an electrode (e.g., the second electrode 197a) driven by a high input voltage (e.g., V5) is inverted to the opposite polarity with a swing width of ΔVh. When a response voltage of an electrode (e.g., the first electrode 193a) driven by a low input voltage (e.g., V4) might not be immediately switched to the opposite polarity and may be reversely changed by ΔV1, and thus, crosstalk noise ΔV1 may occur.

The crosstalk noise is determined by the following Equation 2:

ΔV1={Cb/(Cb+Cl)}×{1/(1+k)}×ΔVh (2),

Here, k={R1(Cb+Cl)}/{R2(Cb+Cr)}, and R1 is a resistance of the first electrode, and R2 is a resistance of the second electrode.

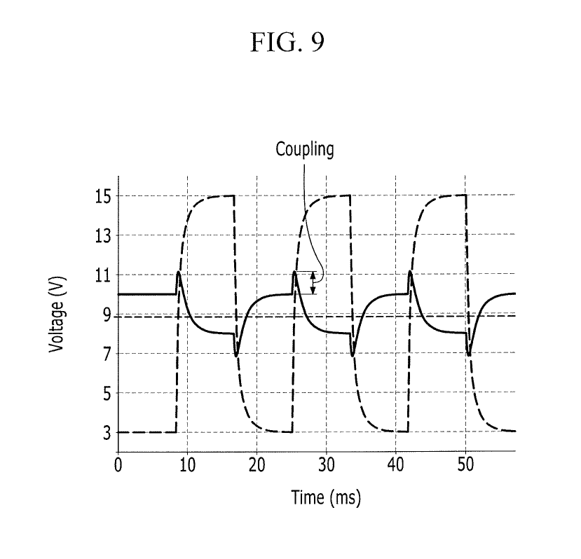

FIG. 9 is a diagram illustrating a simulation result of coupling generated between electrodes adjacent to the zone boundary.

Referring to FIG. 9, the common voltage Vcom applied to the second electrode layer 290 is 9V, the voltage V4 applied to the first electrode 193a adjacent to the zone boundary swings between 10V and 8V, and the voltage V5 applied to the second electrode 197a swings between 3V and 15V. In this case, the response voltage of the second electrode 197a converges at 3V and 15V with a slight delay. The response voltage of the first electrode 193a descends by about 1V or more when being inverted from the negative polarity to the positive polarity, and converges at 10 V. The response voltage of the first electrode 193a ascends by about 1V or more when being inverted from the positive polarity to the negative polarity, and converges at 8 V. Thus, in the response voltage of the first electrode 193a to which a low input voltage having a relatively small absolute value is applied, the delay to the opposite polarity becomes longer and it takes a more time to converge at the input voltage. Thus, image quality on the zone boundary may deteriorate.

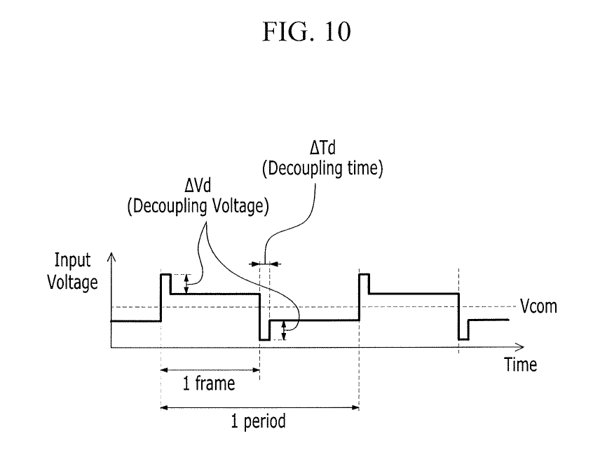

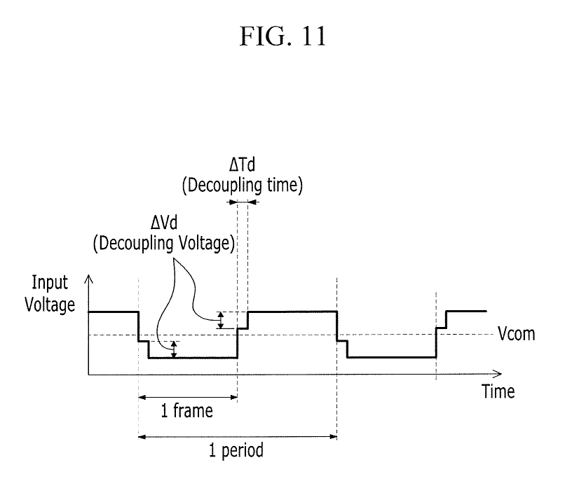

FIGS. 10 and 11 are diagrams illustrating a voltage waveform applied to the electrodes adjacent to a zone boundary according to an exemplary embodiment of the present invention, and FIG. 12 is a diagram illustrating a waveform of a response voltage when a voltage waveform according to the exemplary embodiment of FIGS. 10 and/or 11 is applied to the electrodes adjacent to the zone boundary.

To reduce the coupling effect between the two electrodes 193a and 197a adjacent to the zone boundary and influence by the coupling effect, an input voltage applied to the first electrode 193a is overdriven, as illustrated in FIG. 10, when the input voltage to the first electrode 193a has a relatively small absolute value, or an input voltage to the second electrode 197a is underdriven, as illustrated in FIG. 11, when the input voltage to the second electrode 197a has a relatively large absolute value, or the overdriving for the first electrode 193a and the underdriving for the second electrode 197a may be combined. Here, “overdriving” is understood to bea temporary applying of a voltage having a larger absolute value than a normal voltage (hereinafter, referred to as “overshoot”), and then applying the normal voltage. “Underdriving” is understood to be a temporary applying of a voltage having a smaller absolute value than the normal voltage (hereinafter, referred to as “undershoot”), and then applying the normal voltage.

With respect to the overdriving, referring to FIG. 10, during a frame inversion, a two-step voltage is applied to the electrode to which the low input voltage is applied. The two-step includes a first step in which an overshoot voltage is applied and a second step in which a normal voltage is applied. For example, when the polarity of the voltage applied to the first electrode 193a is changed from positive (+) to negative (−), a voltage which is lower than the normal voltage by a predetermined value (e.g., ΔVd) is applied for a predetermined time (e.g., ΔTd). When the polarity of the applied voltage is changed from negative (−) to positive (+), a voltage which is higher than the normal voltage by a predetermined value (e.g., ΔVd) is applied for a predetermined time (e.g., ΔTd). During the polarity inversion of the low input voltage (e.g., the voltage applied to the first electrode 193a), a phenomenon in which a response voltage (e.g., represented by a dotted line in FIG. 12) of the electrode (e.g., the first electrode 193a) is dragged toward a high input voltage (e.g., the voltage applied to the second electrode 197a) may occur. Thus, the phenomenon may be minimized or removed as illustrated in FIG. 12.

With respect to the underdriving, referring to FIG. 11, during a frame inversion, a two-step voltage is applied to the electrode (e.g., 197a) to which the high input voltage (e.g., V5) is applied. The two-step includes a first step in which an overshoot voltage is applied and a second step in which a normal voltage is applied. Alternatively, the electrode (e.g., 197a) to which the high input voltage (e.g., V5) is applied may be short-circuited to the electrode (e.g., 193a) to which the voltage (e.g., V4) having the opposite polarity is applied, may reach an intermediate voltage (hereinafter, referred to as “charge share”), and the normal voltage may be applied. For example, when the polarity of the voltage applied to the second electrode 197a is changed from positive (+) to negative (−), a voltage which is higher than the normal voltage by a predetermined value (e.g., ΔVd) is applied for a predetermined time (e.g., ΔTd). When the polarity of the applied voltage is changed from negative (−) to positive (+), a voltage which is lower than the normal voltage by a predetermined value (e.g., ΔVd) is applied for a predetermined time (e.g., ΔTd).

In the charge share method, for example, when the first electrode 193a and the second electrode 197a having different polarities are short-circuited from each other for a predetermined time, the second electrode 197a may have an intermediate value of the voltages of the electrodes, and then the normal voltage may be applied to reach the corresponding voltage. As such, during the polarity inversion, the swing width of the high input voltage is reduced, and thus the coupling effect applied to the low input voltage may be reduced. During the polarity inversion of the low input voltage (e.g., the voltage applied to the first electrode 193a), a phenomenon in which a response voltage (e.g., represented by a dotted line in FIG. 12) of the electrode (e.g., the first electrode 193a) is dragged toward a high input voltage may occur. Thus, the phenomenon may be minimized or removed as illustrated in FIG. 12.

In the overdriving and the underdriving, ΔVd and ΔTd may be determined within a range which may reduce an effect of the coupling for the two electrodes adjacent to the zone boundary. Optimal values for ΔVd and ΔTd may vary according to which boundary between zones the first electrode 193a and the second electrode 197a exist in the liquid crystal lens of the liquid crystal panel.

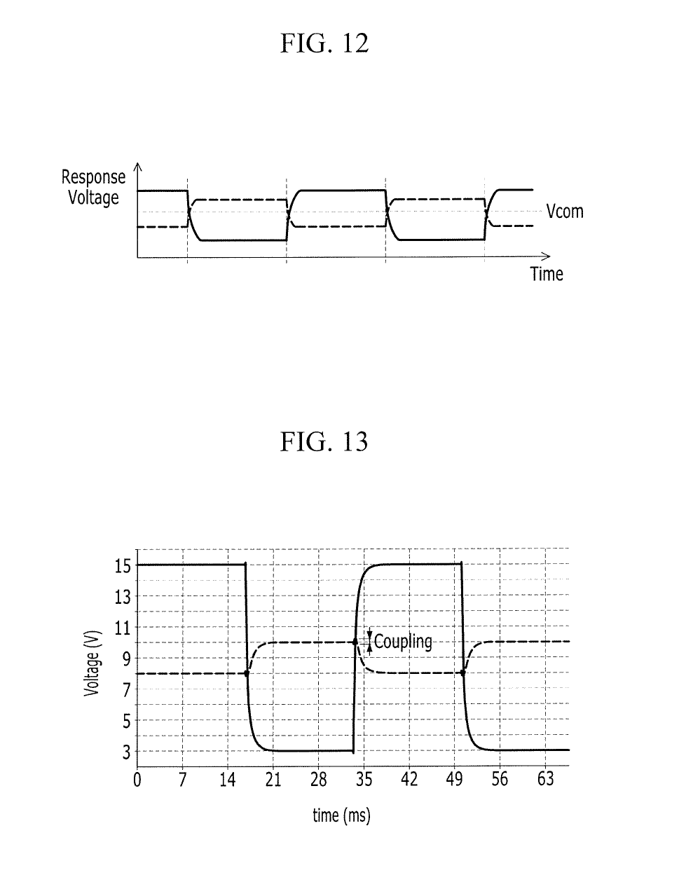

FIG. 13 is a diagram illustrating a simulation result of coupling generated between electrodes adjacent to a zone boundary depending on driving voltages according to an exemplary embodiment of the present invention.

As described above, when the overdriving and the underdriving are applied to the two electrodes (e.g., 193a and 197a) adjacent to the zone boundary, amount of the coupling in the electrode (e.g., 193a) to which the low input voltage (e.g., V4) is applied is reduced during the polarity inversion, as illustrated by a dotted line in FIG. 13. Accordingly, the crosstalk noise due to the coupling effect occurring on the zone boundary may be reduced and deterioration of image quality on the zone boundary may be prevented. Further, a phase on the zone boundary may be maintained. The coupling effect occurring on the zone boundary and the influence thereof may be reduced by driving the electrodes according to an embodiment of the present invention without changing a distance between the electrodes or a thickness.

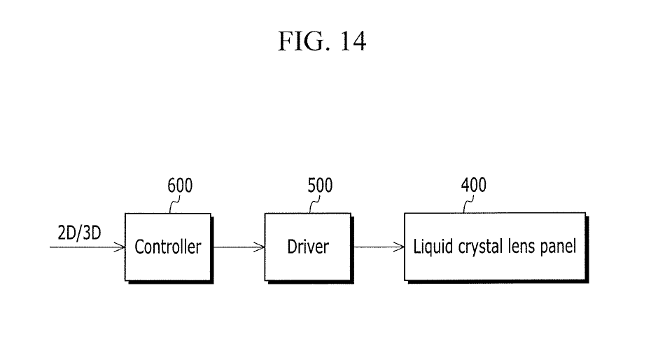

FIG. 14 is a block diagram illustrating a configuration of the liquid crystal lens panel in the display device according to an exemplary embodiment of the present invention.

The display device may include a driver 500, the liquid crystal lens panel 400, and a controller 600. The driver 500 drives the liquid crystal lens panel 400 and the controller 600 controls the driver 500.

The driver 500 supplies different driving voltages in the 2D and 3D modes to the liquid crystal lens panel 400 under the control of the controller 600. In the 2D mode, the driver 500 supplies a voltage in which the liquid crystal lens panel 400 transmits light incident from the display panel 300 as illustrated in FIG. 1. When the liquid crystal lens panel 400 is in a normally white mode, the power supply from the driver 500 may be blocked in the 2D mode. In the 3D mode, the driver 500 forms a distribution in which the phase is delayed according to the Fresnel zone plate for each liquid crystal lens of the liquid crystal lens panel 400 and supplies a voltage in which a viewing field of the image of the display panel 300 is divided as illustrated in FIG. 2.

The controller 600 receives a mode signal 2D/3D from the outside and outputs a control signal corresponding to the mode indicated by the mode signal 2D/3D. For the overdriving and/or the underdriving for the two electrodes 193a and 197a adjacent to the zone boundary described above, the controller 600 may use a plurality of dynamic capacitance compensation (DCC) lookup tables. The DCC lookup table may be stored in an external memory such as an electrically erasable and programmable read-only memory (EEPROM), or the like.

With respect to the DCC lookup table, voltages (e.g., overshoot voltage) corresponding to the lookup table for overdriving may be applied to the electrode (e.g., 193a) to which the low input voltage (e.g., V4) is applied. Voltages (e.g., undershoot voltage) corresponding to the lookup table for underdriving may be applied to the electrode (e.g., 197a) to which the high input voltage (e.g., V5) is applied. The DCC lookup table may vary according to which boundary between zones the first electrode 193a and the second electrode 197a exist in the liquid crystal lens.

As such, the overdriving and the underdriving for the electrodes adjacent to the zone boundary may be implemented by using the DCC lookup table, and hardware such as an additional driver might not be required.

According to an exemplary embodiment of the present invention, the controller 600 may receive a synchronization signal from the outside or a signal controller (not illustrated) of the display panel and may generate a control signal synchronized with driving of the display panel.

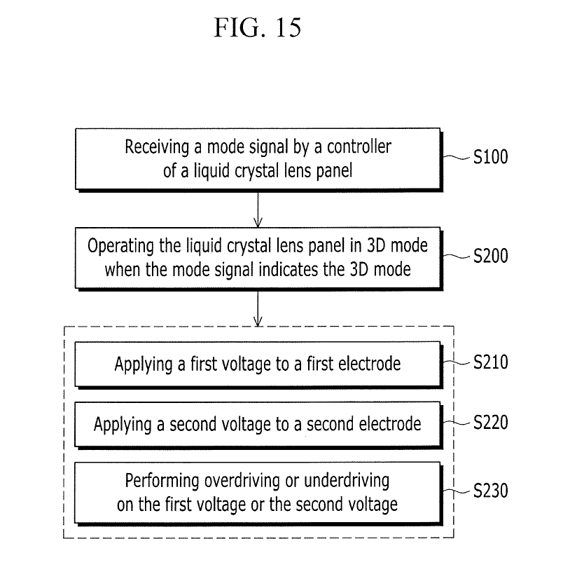

FIG. 15 is a flow chart illustrating a method of driving a display device according to an exemplary embodiment of the present invention.

Referring to FIG. 15, a method of driving a display device according to an embodiment of the present invention may include receiving a mode signal by a controller of a liquid crystal lens panel (S100) and operating the liquid crystal lens panel in 3D mode when the mode signal is a signal representing the 3D mode (S200).

In S200, the operating of the liquid crystal lens may include applying a first voltage to a first electrode that is included in a first zone of a liquid crystal lens in the liquid crystal lens panel and is adjacent to a boundary between the first zone and a second zone of the liquid crystal lens (S210), applying a second voltage to a second electrode that is included in the second zone and is adjacent to the boundary between the first zone and the second zone (S220). Here, the first voltage and the second voltage have opposite polarity to each other with respect to the common voltage. In S200, the; and the operating of the liquid crystal lens may further include performing at least one of operations between overdriving and underdriving on the first voltage or the second voltage (S230).

Although the present inventive concept has been described with reference to exemplary embodiments thereof, it will be understood that the present inventive concept is not limited to the disclosed embodiments and various changes in forms and details may be made therein without departing from the spirit and scope of the present inventive concept.

What is claimed is:

1. A display device, comprising:
a display panel configured to display an image; and
a liquid crystal lens panel including a liquid crystal lens,
wherein the liquid crystal lens panel comprises:
a first substrate;
a second substrate facing the first substrate;
a liquid crystal layer positioned between the first substrate and the second substrate;
a first electrode layer formed on the first substrate, wherein the first electrode layer includes a plurality of electrodes formed on one or more layer; and
a second electrode layer formed on the second substrate, wherein a common voltage is applied to the second electrode layer,
wherein a first voltage is applied to a first electrode that is included in a first zone in the liquid crystal lens, the first electrode is adjacent to a boundary between the first zone and a second zone in the liquid crystal lens,
wherein a second voltage is applied to a second electrode that is included in the second zone, the second electrode is adjacent to the boundary between the first zone and the second zone,
wherein the first voltage and the second voltage have opposite polarities to each other with respect to the common voltage, and
wherein at least one of the first voltage and the second voltage is overdriven or underdriven.

2. The display device of claim 1, wherein:
the first voltage having a smaller absolute voltage than the second voltage is overdriven.

3. The display device of claim 1, wherein:
the second voltage having a larger absolute voltage than the first voltage is underdriven.

4. The display device of claim 1, further comprising:
a driver configured to supply the first voltage and the second voltage to the liquid crystal lens panel; and
a controller configured to control the driver based on at least one lookup table.

5. The display device of claim 4, further comprising:
a memory configured to store the at least one lookup table.

6. The display device of claim 2, wherein:
the overdriving of the first voltage is performed based on a lookup table.

7. The display device of claim 3, wherein:
the underdriving of the second voltage is performed based on a lookup table.

8. The display device of claim 1, wherein:
the first electrode is an electrode to which a smallest absolute voltage is applied among electrodes in the first zone, and
the second electrode is an electrode to which a largest absolute voltage is applied among electrodes in the second zone.

9. The display device of claim 8, wherein:
a difference between the first voltage and the common voltage is larger than zero, and
a difference between the second voltage and the common voltage is larger than zero.

10. A driving method of a display device, the method comprising:
receiving a mode signal by a controller of a liquid crystal lens panel; and
operating the liquid crystal lens panel in a 3D mode when the mode signal is a signal representing the 3D mode,
wherein the operating of the liquid crystal lens includes:
applying a first voltage to a first electrode that is included in a first zone of a liquid crystal lens in the liquid crystal lens panel, wherein the first electrode is adjacent to a boundary between the first zone and a second zone of the liquid crystal lens;
applying a second voltage to a second electrode that is included in the second zone, wherein the second electrode is adjacent to the boundary between the first zone and the second zone, and the first voltage and the second voltage have opposite polarities to each other with respect to the common voltage; and
performing at least one of operations between overdriving and underdriving on the first voltage or the second voltage.

11. The method of claim 10, wherein:
the first voltage having a smaller absolute voltage than the second voltage is overdriven.

12. The method of claim 10, wherein:
the second voltage having a larger absolute voltage than the first voltage is underdriven.

13. The method of claim 10, wherein:
the at least one of the operations is performed based on a lookup table.

14. The method of claim 11, wherein:
the overdriving of the first voltage is performed based on a lookup table.

15. The method of claim 13, wherein:
the underdriving of the second voltage is performed based on a lookup table.

16. The method of claim 10, wherein:
voltages applied to electrodes in each of the first zone and the second zone vary stepwise and differences of the voltages from the common voltage gradually decrease toward the center of the liquid crystal lens from the outer side.

17. The method of claim 16, wherein:
a difference between the first voltage and the common voltage is larger than zero, and
a difference between the second voltage and the common voltage is larger than zero.

18. The method of claim 10, wherein:
the underdriving is performed by charge sharing.

19. The display device of claim 1, wherein:
the liquid crystal lens panel operates in a 2D mode or a 3D mode, and the liquid crystal lens operates as a Fresnel zone plate when the liquid crystal lens operates in the 3D mode.

20. A display device, comprising:
a display panel configured to display an image; and
a liquid crystal lens panel including a liquid crystal lens,
wherein the liquid crystal lens panel comprises:
a first electrode layer having a first zone and a second zone, wherein each of the first zone and the second zone includes a plurality of electrodes, and the first zone and the second zone are adjacent to each other; and
a second electrode layer to which a common voltage is applied,
wherein a first voltage is applied to a first electrode that is included in the first zone, and the first electrode is adjacent to a boundary between the first zone and the second zone,
wherein a second voltage is applied to a second electrode that is included in the second zone, and the second electrode is adjacent to the boundary between the first zone and the second zone,
wherein the first voltage and the second voltage have opposite polarities to each other with respect to the common voltage, and an absolute voltage of the first voltage is smaller than an absolute voltage of the second voltage, and
wherein the first voltage is overdriven and the second voltage is underdriven.
